(19) United States
(12) Patent Application Publication
(10) Pub. No.: US 2012/0236063 A1
(43) Pub. Date: Sep. 20, 2012

(54) DISCHARGE TESTING DEVICE

(75) Inventor: Yoshio NAKAZAWA, Chino-shi (JP)

(73) Assignee: SEIKO EPSON CORPORATION, Tokyo (JP)

(21) Appl. No.: 13/422,975

(22) Filed: Mar. 16, 2012

(30) Foreign Application Priority Data
Mar. 18, 2011 (JP) 2011-060486

(51) Int. Cl. B41J 29/393

(52) U.S. Cl. 347/19

(57) ABSTRACT

A discharge testing device comprising:
a discharge controller discharging a liquid droplet from a nozzle such that a discharge testing period including a discharge period; a detection signal acquiring unit acquiring a detection signal; a low-pass filter eliminating a high frequency component from the detection signal; a first amplifier amplifying the detection signal to generate a first amplification signal; a restricting unit restricting signal strength of the first amplification signal during a restriction period included in the discharge testing period to predetermined strength; a second amplifier amplifying the first amplification signal to generate a second amplification signal; and a determinator determining whether a liquid droplet is normally discharged based on signal strength based on signal strength of a second amplification signal during a sampling period after a predetermined time elapses from the restriction period.

### CROSS-REFERENCE TO RELATED APPLICATIONS

This application claims priority to Japanese Patent Application No. 2011-060486 filed on Mar. 18, 2011. The entire disclosure of Japanese Patent Application No. 2011-060486 is hereby incorporated herein by reference.

### BACKGROUND

1. Technical Field

The present invention relates to a discharge testing device for determining whether a liquid droplet is discharged normally.

2. Related Art

A liquid discharge device has been proposed which includes a vibration plate on which a liquid droplet discharged from a nozzle is landed and determines clogging of a nozzle based on a voltage signal changed by mechanically vibrating the vibration plate (refer to Japanese Patent No. 4501461). The liquid discharge device extracts, through a band-pass filter, a signal component of a frequency band caused by a liquid droplet landed on a vibration plate, and determines that a nozzle is clogged when the signal component is smaller than a predetermined voltage.

However, a band-pass (bypass) filter has a problem in that a signal wave of a voltage signal caused by the liquid droplet landed on the vibration plate is distorted or delayed. In particular, there is a problem in that a time period required to test clogging of a nozzle is extended due to the occurrence of a delay in the signal wave of the voltage signal. In order that the signal waveforms between different nozzles not be superimposed, the liquid droplet of the next nozzle should be discharged after waiting for the signal waveform of the voltage signal caused by the liquid droplet discharged from a given nozzle to return to normal. Accordingly, when the signal waveform of the voltage signal is delayed, the period required to test a plurality of nozzles is extended. Further, in Japanese Patent No. 4501461, since there is also a need to await the mechanical vibration of the vibration plate itself returning to normal, a problem arises in that the period required for testing is easily lengthened.

### SUMMARY

An advantage of some aspects of the invention is that it provides a discharge testing device determining whether a liquid droplet is discharged normally within a short time.

According to an aspect of the invention, there is provided a discharge testing device. In the discharge testing device, a discharge controller discharges a liquid droplet from a nozzle such that a discharge testing period including a discharge period in which a liquid droplet is discharged from a nozzle and a non-discharge period in which the liquid droplet is not discharged from the nozzle is repeated. A detection signal acquiring unit acquires a detection signal whose signal strength varies in response to a liquid droplet discharged from a nozzle during the discharge period. A low-pass filter eliminates a high frequency component from a detection signal, and a first amplifier amplifies a detection signal and generates a first amplification signal. Further, a restricting unit restricts the signal strength of a first amplification signal to predetermined strength during a restriction period included in the discharge testing period. A second amplifier amplifies a first amplification signal to generate a second amplification signal. A determinator determinates whether a liquid droplet is normally discharged from a nozzle based on the signal strength of a second amplification signal during a sampling period after a predetermined time elapses from the restriction period.

Since the restriction period is included in the discharge testing period, the signal strength of a first amplification signal having a period equal to or shorter than the discharge testing period is restricted to predetermined strength. In so doing, a noise component in the signal strength is prevented from being accumulated through a plurality of discharge testing periods. Accordingly, influence of a low frequency noise component superimposed on the first amplification signal may be suppressed. Further, it may be compared with a case of suppressing a low frequency noise component using a high-pass filter to prevent waveform distortion and delay of the detection signal, and the time period required to the discharge of a liquid droplet from a nozzle to the performance of the determination process by the determinator may be reduced. Accordingly, by repeating a large number of discharge testing periods, the time period required for performing discharge testing for a plurality of nozzles may be reduced. On the other hand, because a low-pass filter eliminates a high frequency component from a detection signal, it may suppress the influence of a high frequency noise component superimposed on the first amplification signal. Accordingly, a determination result having high noise resistance may be obtained. Furthermore, since a second amplifier is provided in addition to the first amplifier, although the amplification rate in the first amplifier is suppressed, it may be supplemented by the second amplifier. Accordingly, this may prevent the first amplification signal from exceeding an output possible range of the first amplifier, distortion of a signal wave due to clipping may be prevented, and deterioration of determination precision due to distortion of the signal wave may be prevented.

Further, the first amplifier may generate a first amplification signal indicating a voltage varying in response to a liquid droplet discharged from a nozzle in a first amplification circuit. In addition, the restricting unit may include a coupling capacitor disposed between an output terminal of the first amplification circuit and an input terminal of the second amplification circuit of the second amplifier, a restricting point provided between the coupling capacitor and the input terminal of the second amplification circuit, a power source circuit generating power of a predetermined electric potential, and a switch inputting corresponding power in a restriction period to the restricting point. In so doing, an electricity amount charged in the coupling capacitor during the convergence period may be initialized with an electricity amount corresponding to a predetermined electric potential. Accordingly, a voltage of the first amplification signal may be restricted in a predetermined electric potential in the restriction period, and a voltage of a first signal generated by the first amplifier may be input in an input terminal of the second amplification circuit.

In addition, a secondary restricting unit restricting signal strength of a first amplification signal during a secondary restriction period after a sampling time instead thereof during a discharge testing period may be included. Moreover, the determinator may determine whether a liquid droplet is normally discharged in consideration of signal strength of the second amplification signal in a secondary sampling time after a predetermined time elapses from the secondary restriction period. That is, during a single discharge testing period, two sets of convergence and sampling are provided, so that determination may be made in consideration of signal strength of a second amplification signal in two sampling times, and reliance of the determination may be improved. Because restriction is performed to reduce the influence of low frequency noise with suppression of delay in the detection signal, although a set of restriction and sampling is provided twice, the time required for discharge testing being lengthened may be prevented.

A restricting unit restricts signal strength of a first amplification signal with predetermined strength, but a switch switching to the predetermined strength in a plurality of strengths may be provided. Here, the signal strength of the first amplification signal is restricted to a predetermined strength and is changed based on a predetermined strength. Accordingly, the restricting unit switches a predetermined strength restricting signal strength of the first amplification signal, and a strength band whose signal strength of the first amplification signal varies may be adjusted. That is, when noise is included in a signal strength of the first amplification signal, the strength signal is switched such that a signal strength of the first amplification signal may be changed to the strength band in which the signal strength of the first amplification signal have no problems. For example, signal strength of the first amplification signal does not exceed an output allowable range, and waveform distortion may be prevented due to clamp of the first amplification signal.

Further, the discharge testing device may further includes a plurality of signal generators that include a detection signal acquiring unit, a low-pass filter, a first amplifier, a restricting unit, and a second amplifier, and the detection signal acquiring units may acquire a detection signal whose signal strength varies in response to liquid droplets discharged from different nozzles, respectively. In doing so, discharge testing for different nozzles may be performed in a parallel way, and the period required to perform discharge testing for a plurality of nozzles may be reduced.

### BRIEF DESCRIPTION OF THE DRAWINGS

The invention will be described with reference to the accompanying drawings, wherein like numbers reference like elements.

FIG. 1 is a pattern diagram illustrating the concept of an embodiment.

FIG. 2 is a block diagram illustrating a discharge testing device.

FIG. 3 is a block diagram illustrating a discharge testing device.

FIG. 4 is a timing chart of discharge testing.

FIG. 5A to FIG. 5D are graphs illustrating a detection voltage, and FIG. 5E is a graph illustrating amplitude of a detection voltage.

FIG. 6A and FIG. 6B are graphs illustrating a detection voltage, and FIG. 6C is a graph illustrating a noise suppression characteristic of a detection voltage.

FIG. 7 is a block diagram illustrating main parts of a discharge testing device according to a second embodiment.

FIG. 8 is a timing chart of a discharge testing according to a second embodiment.

FIG. 9A and FIG. 9B are timing charts of discharge testing according to another embodiment, FIG. 9C is a block diagram illustrating a sampling unit, and FIG. 9D is a circuit diagram illustrating a sampling unit.

### DESCRIPTION OF EXEMPLARY EMBODIMENTS

Hereinafter, the embodiments of the invention will be described below with reference to the accompanying drawings.

1. Brief explanation of embodiment
2. First embodiment
2-1. Configuration of discharge testing device
2-2. Operation of discharge testing device
3. Second embodiment
4. Another embodiment

### 1. BRIEF EXPLANATION OF EMBODIMENT

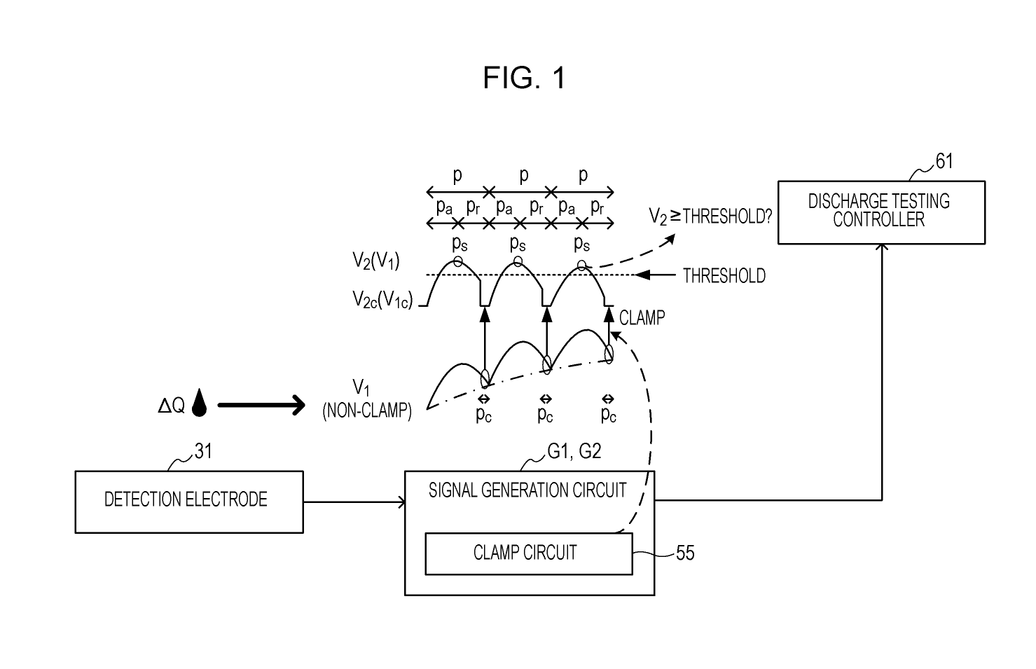

FIG. 1 shows a concept of an embodiment. A discharge testing device of this embodiment includes a detection electrode 31 constituting one electrode of a capacitor whose capacitance is parasitized, and lands an ink droplet on a corresponding detection electrode 31 as a liquid droplet to create a charge variation amount ΔQ in the detection electrode 31. Signal generation circuits G1 and G2 generate a detection voltage V₂ including a response wave of a charge variation amount ΔQ. The response wave of the detection voltage V₂ is gradually increased to a maximum value during a discharge period pₐ when the ink droplet is discharged to a detection electrode 31, and is slowly reduced to restriction during a non-discharge period pᵣ when the ink droplet is not discharged. A discharge testing period p for one nozzle includes the discharge period pₐ and the non-discharge pᵣ. By repeating the discharge testing period while sequentially switching the nozzle discharging the ink droplet, discharge testing for a plurality of nozzles is sequentially performed. Here, because a response wave of a detection voltage V₂ according to a charge variation amount ΔQ is restored from start of the discharge period Pₐ, it is expressed with the same period as the discharge testing period p. The signal generation circuits G1 and G2 include a clamp circuit 55. The clamp circuit 55 restricts an intermediate voltage V₁ to a predetermined electric potential V_{1c} during a clamp P_{c} (advent with the same period as discharge testing period p). In doing so, a detection voltage V₂ increased from the intermediate voltage V₁ may be restricted to a predetermined electric potential V_{2c} during a clamp period p_{c}. As illustrated above, a detection voltage V₂ is restricted to a predetermined electric potential V_{2c} during a clamp period pc which has come to the same period as the discharge testing period p, such that noise (dashed line) of a frequency lower than the discharge testing period p through a plurality of discharge testing periods p may be prevented from being accumulated.

The discharge testing controller 61 acquires a voltage value of a detection voltage V₂ during a sampling period pₛ being a period making the transition from the discharge period pₐ to a non-discharge period pᵣ. That is, the discharge testing controller 61 determines a transition time period from increase in the detection voltage V₂ to reduction therein as a sampling period pₛ to acquire a voltage value of a detection voltage V₂ when a response wave of a charge variation amount ΔQ becomes a maximum value. Further, the discharge testing controller 61 determines that an ink droplet is normally discharged where a voltage value of a detection voltage V₂ during the sampling period ps is equal to or greater than a predetermined threshold (broken line). Because the detection voltage V₂ is restricted to a known constant electric potential V_{2c} immediately before a discharge period pₐ when the detection voltage V₂ starts to increase by the charge variation amount ΔQ, including the detection voltage V₂ during the sampling period pₛ being equal to or greater than a predetermined threshold, and it may be determined that a variation amount of a detection voltage V₂ varies in response to a charge variation amount by the ink droplet is appropriate. In doing so, it may prevent low frequency noise from being accumulated through a plurality of discharge testing periods, and it is determined with accuracy whether amplitude of a response wave of a charge variation amount ΔQ created during a discharge testing period p. Here, because low frequency noise is eliminated by a clamp circuit 55 regardless of a high-pass filter having a high cut-off frequency, distortion or delay in a signal wave may be suppressed. Accordingly, a discharge testing period p may be reduced, and a predetermined period required for discharge testing for a plurality of nozzles may be reduced.

### 2. FIRST EMBODIMENT

### 2-1. Configuration of Discharge Testing Device

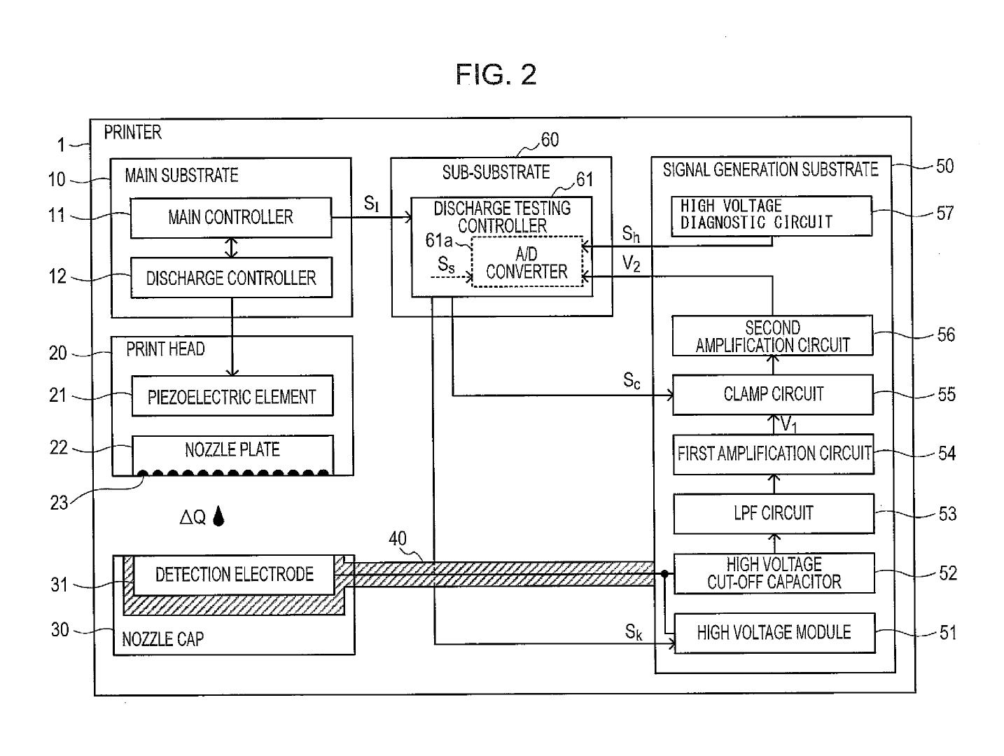

FIG. 2 is a block diagram illustrating a printer 1 including a discharge testing device according to a first embodiment. The printer 1 includes a main substrate 10, a print head 20, a nozzle cap 30, a shield structure 40, a signal generation substrate 50, and a sub-substrate 60. A printer 1 of a first embodiment is an ink-jet printer. The main substrate 10 includes a main controller 11 and a discharge controller 12. The main controller 11 is configured by a CPU, a RAM, a ROM, an ASIC, and the like, and performs a process that generates printing data based on image data acquired through an interface unit (not shown), and outputs corresponding printing data to the discharge controller 12. Further, the main controller 11 performs a process that notifies the result of discharge testing to be described later through a user interface unit (not shown). The discharge controller 12 includes a CPU, a RAM, a ROM, an ASIC, and the like, and performs a process that generates driving data to be output to the print head 20 based on printing data. Here, the discharge controller 12 performs driving control of the print head 20 for each predetermined latch period (about 87 μs). The latch period is specified by a latch signal S₁, and the latch signal S₁ is generated by the main controller 11. Here, the latch signal S₁ is a binary signal having signal level of 0 or 1, and a signal level thereof becomes 1 for each timing when the latch period starts.

The print head 20 includes a piezoelectric element 21, a nozzle plate 22, and a nozzle 23. The print head 20 receives the supply of an ink from an ink tank, and discharges an ink droplet (liquid droplet) of a corresponding ink (not shown) from the nozzle 23. The print head 20 includes a plurality of nozzles 23, and the nozzle 23 is aligned in the nozzle head 22 on a plane facing the recording medium (not shown) in parallel. A plurality of nozzles 23 and ink chambers (not shown) communicate with each other, respectively, and the ink from the ink tank is supplied into the ink chamber. A driving pulse is applied to a piezoelectric element 21 included in each of the ink chambers based on driving data created by the discharge controller 12. The piezoelectric element 21 is mechanically deformed by a driving pulse to increase and reduce the pressure on ink in an ink tank. In doing so, the ink droplet is discharged from the nozzle 23. The nozzle plate of this embodiment is formed of stainless, and is grounded to a reference electric potential 0V.

The nozzle cap 30 may include a detection electrode 31 as a detection signal acquiring means. For example, the detection electrode 31 is an electrode of a plane that faces the nozzle plate 22 in parallel. A nozzle cap 30 is operated such that the detection electrode 31 and the nozzle plate 22 are adhered to each other to prevent drying or solidification of the ink in the nozzle 23. The detection electrode 31 may be a mesh electrode in which a landed ink droplet is permeated, and may absorb ink with a sponge or the like included in a rear side of the detection electrode (opposite side of nozzle plate 22) or generate a liquid by a waste liquid tube. Further, during printing or discharge testing, the nozzle cap 30 is separated from the print head 20, and the nozzle plate 22 and the detection electrode 31 face each other in parallel with a width corresponding to the predetermined distance.

The shield structure 40 includes a protecting unit for protecting a detection electrode 31 and a cable connecting a detection electrode 31 with a signal generation substrate 50 from external cause of magnetic disturbance. Here, the shield structure 40 may be a module structure that integrates and protects the detection electrode 31 and the signal generation substrate 50. Further, the shield structure 40 may coat a waste liquid tube provided in the nozzle cap 30 and protect the waste liquid tube and the like from a cause of magnetic disturbance.

The signal generation substrate 50 includes a high voltage module 51, a high voltage cut-off capacitor 52, a low-pass filter circuit 53, a first amplification circuit 54, a clamp circuit 55, a second amplification circuit 56, and a high voltage diagnostic circuit 57.

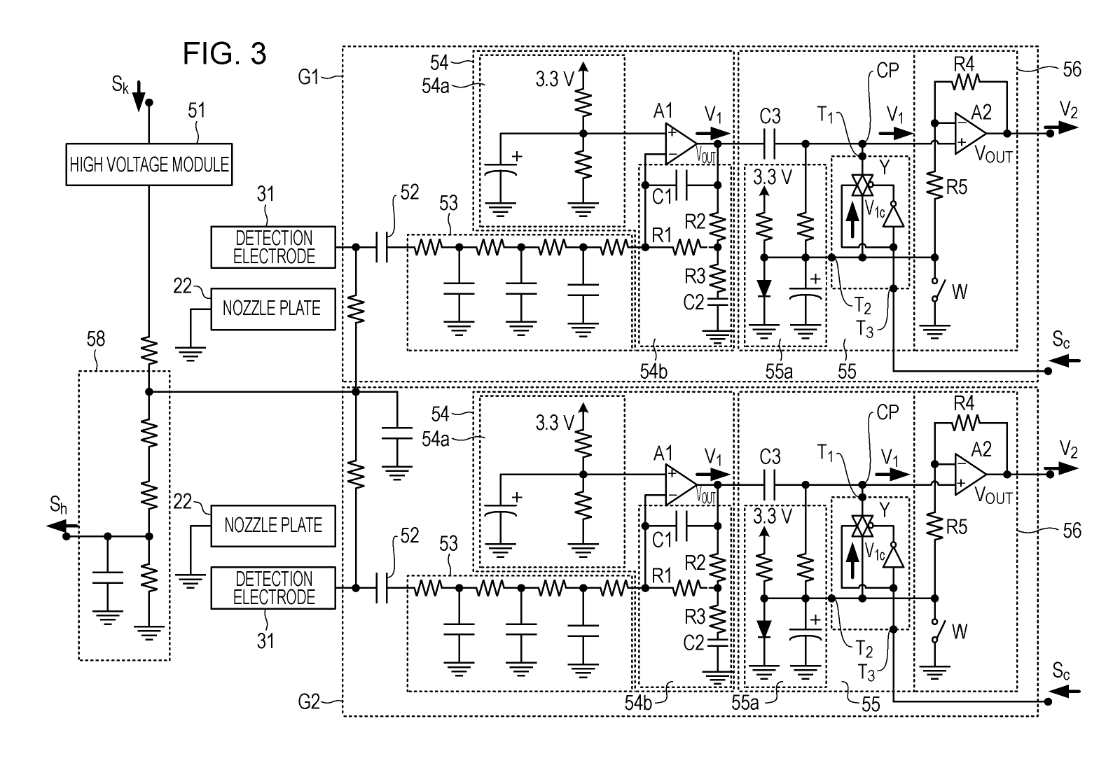

FIG. 3 is a circuit diagram of a signal generation substrate 50. Two signal generation circuits G1 and G2 are provided at the signal generation substrate 50, and each of the signal generation circuits G1 and G2 includes a high voltage cut-off capacitor 52, a low-pass filter circuit 53, a first amplification circuit 54, a clamp circuit 55, and a second amplification circuit 56. The high voltage module 51 is connected with a detection electrode 31, and outputs a high voltage (e.g., 100 to 500V) at the time of discharge testing through a load-resistor. Accordingly, at the time of discharge testing, a charge of a charge amount Q of Q=CV (V is high voltage) is stored in a parasitic capacitance C parasitized between the detection electrode 31 and a nozzle plate 22 of a reference electric potential. At the time of discharge testing, a discharge controller 12 discharges an ink droplet from the nozzle 23. An ink droplet discharged from the nozzle 23 is landed on the detection electrode 31, and a small charge variation amount ΔQ is produced in a charge amount Q of the detection electrode 31 by a charge which an ink droplet carries from a nozzle plate 22 to a detection electrode 31. At this time, a small current corresponding to a charge variation amount ΔQ flows to a detection electrode 31 through a load-resistor.

In the discharge testing, a distance between the nozzle plate 22 and the detection electrode 31 ideally maintains a constant distance. However, when a nozzle plate 22 vibrates due to discharge of an ink droplet in the nozzle plate 22 or at least one of the nozzle plate 22 and the detection electrode 31 vibrates due to other causes, the distance between the nozzle plate 22 and the detection electrode 31 changes. In doing so, capacitance between the nozzle plate 22 and the detection electrode 31 varies and a slight charge variation amount ΔQ may occur in the detection electrode 31. That is, an electric current corresponding to a charge variation amount ΔQ caused by other causes of noise as well as a charge variation amount ΔQ due to landing of an ink droplet are superimposed on a small electric current flowing through the detection electrode 31.

A detection electrode 31 is separately connected with each of the signal generation circuits G1 and G2, and the detection electrodes 31 face different locations of nozzle plates 22. That is, a nozzle 23 landing an ink droplet on the detection electrode 31 becomes different. Here, a high voltage is applied by a high voltage module 51 in common with each of detection electrodes 31 to reduce the cost. Further, the detection electrode 31 is protected from cause of magnetic disturbance occurring from for example a commercial power source or another circuit that a printer 1 includes through the shield structure 40. Because the signal generation circuits G1 and G2 have the same configuration with the exception of a location of a connected detection electrode 31, only one is now described. An electrode of one of the high voltage cut-off capacitors is connected with the detection electrode 31 through a cable protected by the shield structure 40. As illustrated above, when the shield structure 40 is provided, noise is superimposed on a signal from a cause of magnetic disturbance in a signal generation procedure of the signal generation circuits G1, G2.

Another electrode of the high voltage cut-off capacitors 52 is connected to a low-pass filter circuit 53. With cutting-off a high voltage by the high voltage cut-off capacitor 52 to protect the low-pass filter circuit 53 and the like, a small electric current as a detection signal corresponding to a small charge variation amount ΔQ in the detection electrode 31 may be caused to flow to the low-pass filter circuit 53. The low-pass filter circuit 53 is a circuit for eliminating frequency components higher than a predetermined frequency (2 kHz) from a small electric current. In doing so, noise of a high frequency may be eliminated from the small electric current. The low-pass filter circuit 53 according to this embodiment is a T type low-pass filter circuit that T-connects a capacitor grounded to an input resistor with an output resistor.

The first amplification circuit 54 inputs a small electric current from which a high frequency component is eliminated by the low-pass filter circuit 53, and converts a small electric current into a voltage and amplifies the voltage at the same time. The first amplification circuit includes an operational amplifier A1, a normal phase circuit 54a, and a feedback resistor circuit 54b. Input impedance of the first amplification circuit 54 is virtually 0, and an operational amplifier A1 receives a small electric current from a low-pass filter circuit 53 at an inverting input terminal (−). A normal phase input circuit 54a inputs a voltage of 1.65V obtained by dividing a predetermined power-supply voltage (3.3V) by two voltage division resistors having the same resistance in a non-inverting input terminal (+) of the operational amplifier A1. A feedback resistor circuit 54b includes feedback resistors R1 to R3 and capacitors C1 and C2, and is provided between an output terminal Vout and an inverting input terminal (−) of the operational amplifier A1. Further, a capacitor C2 of 10 μF connects with a feedback voltage division resistor R3 (510Ω) of the feedback resistor circuit 54b, so that an auto-bias voltage of 1.65V is input to the operational amplifier A1 in the same manner in a non-inverting input terminal (+). Here, an amplification coefficient X₁ of the first amplification circuit 54 becomes X₁=1MΩ×(5.1 kΩ+510Ω)/510Ω=11MΩ by resistances (R1:1MΩ, R2:5.1 kΩ, R3:510Ω) of respective feedback resistances R1 to R3 of the feedback resistor 54b. Accordingly, an intermediate voltage V₁ (first amplification signal) as an output voltage of an output terminal (Vₒᵤₜ) of the operational amplifier A1 becomes V₁=−X₁×I (I is a current value of a small electric current given in the inverting input terminal (−). Here, it is preferred that variation of resistances of respective feedback resistors R1 to R3 determining an amplification coefficient X₁ is managed with a predetermined reference (e.g., maximum error is within 1%).

A capacitor C1 for phase compensation is provided at the feedback resistor circuit 54b. Capacitance of the capacitor C1 for phase compensation is adjusted to about 10 to 15 pF, so that a gain in a high frequency band of the intermediate voltage V₁ is optimized. Here, a low-pass filter circuit 53 may be configured by a T type low-pass filter circuit to insert an output resistor of a low-pass filter circuit 53 between a grounded capacitor of the low-pass filter circuit 53 and a feedback resistor circuit 54b of the first amplification circuit 54. In doing so, the first amplification circuit 54 may be stabilized, and may be prevented from entering an oscillation state.

The clamp circuit 55 as the restricting means includes coupling capacitors C3, a power circuit 55a, and an analog switch Y. An intermediate voltage V₁ from a first amplification circuit 54 is input to an electrode of one of the coupling capacitors C3, and a second amplification circuit 56 is connected with an electrode of another one of the coupling capacitors C3. The second amplification circuit 56 includes an operational amplification A2 and feedback resistors R4 and R5, and an intermediate voltage V1 of the first amplification circuit 54 is input to a non-inverting input terminal (+) of the operational amplification A2. The second amplification circuit 56 is a non-inverting amplification circuit, amplifies an intermediate voltage V₁ of the first amplification circuit 54, and outputs a detection voltage V₂ (second amplification signal). Here, an amplification rate X₂ of the second amplification circuit 56 becomes X₂=(51 kΩ+510Ω)/510Ω=101 times the resistances of feedback resistors R4, R5(R4:51 kΩ, R5:510Ω. Accordingly, a detection voltage V₂ in an output terminal (Vₒᵤₜ) of the operational amplifier A2 becomes V₂=X₂×V₁. Here, it is preferred that the variation of resistances of respective feedback resistors R4 and R5 determining an amplification coefficient X₂ is managed with a predetermined reference (e.g., maximum error is within 1%).

As illustrated above, the first amplification circuit 54 and the second amplification circuit 56 are sequentially connected, but one terminal T₁ of an analog switch Y of a clamp circuit 55 in a clamp point (restricting point) CP between the first amplification circuit 54 and the second amplification circuit 56 is connected. A power circuit 55a is connected to a terminal T2 of another one of the analog switches Y. The power circuit 55a divides a predetermined source voltage (3.3V) by a resistor and a diode of a forward direction to generate a constant electric potential V_{1c} (0.6V). The constant electric potential X_{1c} is input to a terminal T₂ of the analog switch Y. The analog switch Y has a control terminal T₃, and a clamp signal S_{c} from a discharge testing controller 61 is input to the control terminal T₃. The clamp signal S_{c} is a binary signal of 1 when a single level is 0 and it becomes 1 only during a clamp period to be described later. For example, the analog switch Y is a CMOS switch, and conducts between terminals T₁, T₂ during only a period when the clamp signal S_{c} becomes 1. In doing so, an electricity amount charged in a coupling capacitor C3 is restricted in an electricity amount corresponding to a predetermined electric potential V_{1c} by power of a predetermined electric potential V_{1c} during the clamp period, and a coupling capacitor C3 is charged or discharged according to a charge variation amount ΔQ during periods other than the clamp period. That is, an intermediate voltage v₁ is restricted to a predetermined electric potential v_{1c} during only a clamp period. Here, there is also a case where an intermediate voltage V₁ conducting an analog switch Y is restricted to a predetermined electric potential V_{1c}. Here, the intermediate voltage V₁ is clamped to a predetermined electric potential V_{1c}, so that a detection voltage X₂ from the second amplification circuit 56 is also restricted to a predetermined electric potential V_{2c}=X₂×V.

The second amplification circuit 56 has a switch W for bringing an electric potential of a terminal T₂ of an analog switch Y to a ground, and through conducting by the switch W, a power circuit 55a may switch a predetermined electric potential V1c to be output to a terminal T₂ of an analog switch Y from 0.6V to 0V. Here, a conducting state in a switch W is controlled by a switch signal (not shown) output from a discharge testing controller 61. Meantime, a coupling capacitor C3 alternating-current couples the first amplification circuit 54 and the second amplification circuit 56, capacitance of the coupling capacitor C3 and input impedance of the second amplification circuit 56 are set such that a time constant is sufficiently longer than a clamp opening period (non-clamp period). A high voltage diagnostic circuit 57 divides a high voltage generated from a high voltage module 51 by a plurality of resistors to generate a high voltage cut-off signal Sₕ.

A sub-substrate 60 as shown in FIG. 2 includes a discharge testing controller 61. The discharge testing controller 61 is configured by a CPU, a RAM, a ROM, or an IC such as an ASIC and an A/D converter 61a. The discharge testing controller 61 creates a digital signal obtained by quantizing a voltage value of a detection voltage V₂ output from the second amplification circuit 56 by an A/D converter 61 during a sampling period. Here, the sampling period is specified based on a sampling signal. The sampling signal Sₛ is a binary signal of 0 when a signal level is 1, and a discharge testing controller 61 acquires a voltage value of a detection voltage V₂ during only a period when a signal level of the sampling signal Sₛ becomes 1. The discharge testing controller 61 as a determination means determines whether an ink droplet is discharged normally from a nozzle 23 based on a digital signal indicating a voltage value of a detection voltage V₂. If the ink droplet is discharged normally from the nozzle 23, an appropriate charge variation amount ΔQ is generated in the detection electrode 31, and a response wave corresponding to a charge variation amount ΔQ will be finally expressed in a detection voltage V₂ output from the second amplification circuit 56. The discharge testing controller 61 determines whether an ink droplet is normally discharged from a nozzle 23 by determining whether a response wave of a detection voltage V₂ corresponding to a charge variation amount ΔQ is expressed through comparison of a voltage value of the detection voltage V₂ with a predetermined threshold.

Further, the discharge testing controller 61 generates a clamp signal designating a clamp period expressed by a latch signal S₁, and outputs the clamp signal to an analog switch Y of a clamp circuit 55. In addition, the discharge testing controller 61 converts a high voltage cut-off signal Sₕ into a digital signal by an A/D converter 61a, monitors abnormality (voltage droplet, excessive voltage) of a high voltage due to abnormality of a high voltage module 51 or an abnormal voltage droplet of a high voltage due to ground short-circuit (leak) of a detection electrode 31 and the like. Further, the discharge testing controller 61 outputs a high voltage control signal Sₖ for generating a high voltage to the high voltage module 51. The high voltage control signal Sₖ is a binary signal where a signal level is 1 or 0, and the high voltage module 51 generates a high voltage during only a period when the signal level of the high voltage control signal Sₖ is 1.

### 2-2. Operation of Discharge Testing Device

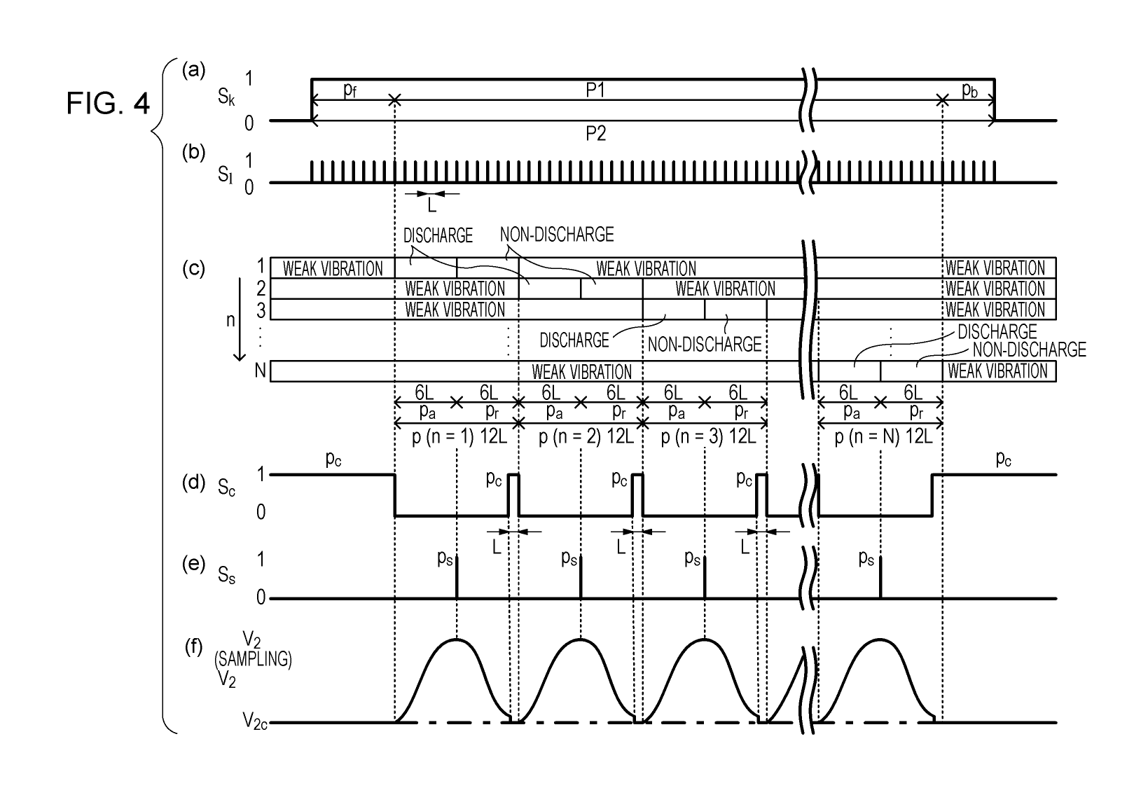

FIG. 4 is a timing chart of discharge testing performed by a discharge testing device. In (a) of FIG. 4, a high voltage control signal Sₖ is illustrated. A high voltage module 51 outputs a high voltage during an entire testing period P2 when a signal level of the high voltage control signal becomes 1. The entire testing period P2 includes a prefix period p_{f}, an actual testing period P1, and a postfix period p_{b} in an order of earlier time. Here, a high voltage is output to a high voltage module 51 during the prefix period p_{f}, so that the high voltage cut-off capacitor 52 is sufficiently charged in comparison with the entire testing period P1. In (b) of FIG. 4, a wave form of a latch signal indicating a latch period is illustrated. Here, the length of the latch period is expressed with L.

In (c) of FIG. 4, discharge states of respective nozzles 23 are illustrated. In this embodiment, a print head 20 has N nozzles 23 landing an ink droplet with respect to two detection electrodes 31, respectively, and a nozzle number (n=1, 2, 3, . . . N) is indexed to each of the detection electrodes 31 landing the ink droplet. Further, discharge testing for respective nozzles 23 is performed in ascending order of the nozzle order. A period (discharge testing period p) required to test discharge of each nozzle 23 is constant, a period obtained by multiplying a length of the discharge testing period p by the number of nozzles becomes an actual testing period P1 required for discharge testing of all the nozzles. In this embodiment, a print head 20 includes 5760 nozzles 23, and the number (N) of nozzles 23 landing an ink droplet on one detection electrode 31 is 2880.

The length of a discharge testing period p is a multiple of a length L of the latch period, and in this embodiment, the length of a discharge testing period p is twelve times the length L of the latch period. In addition, a period from start of the discharge testing period p to elapse of 6 latch periods (6L) becomes a discharge period pₐ. A discharge controller 12 of the main substrate 10 discharges an ink droplet from a nozzle 23 of a discharge testing target 24 times. That is, during each latch period included in the discharge period pₐ, the discharge controller 12 discharges an ink droplet from a nozzle 23 of a discharge testing target four times. A time period from an end of the discharge period pₐ to a discharge testing period p becomes a non-discharge period pᵣ. During the non-discharge period pᵣ, the discharge controller 12 does not discharge an ink droplet from a nozzle 23 of a discharge testing target. Further, the discharge controller 12 does not discharge the ink droplet from a nozzle 23 except for the discharge testing target without limiting a discharge period pₐ or a non-discharge period pᵣ. However, the discharge controller 12 slightly vibrates an ink liquid surface in a nozzle 23 except for the discharge testing target in degree such that an ink droplet is not discharged (described in another embodiment). Here, the length of a discharge testing period p, a discharge period pₐ, or a non-discharge period pᵣ is recorded on a recording medium (ROM, register, etc.) which the discharge controller 12 or the discharge testing controller 61 may read out. Here, the basis of the discharge testing period p, the discharge period pₐ, or the non-discharge period pᵣ will be described.

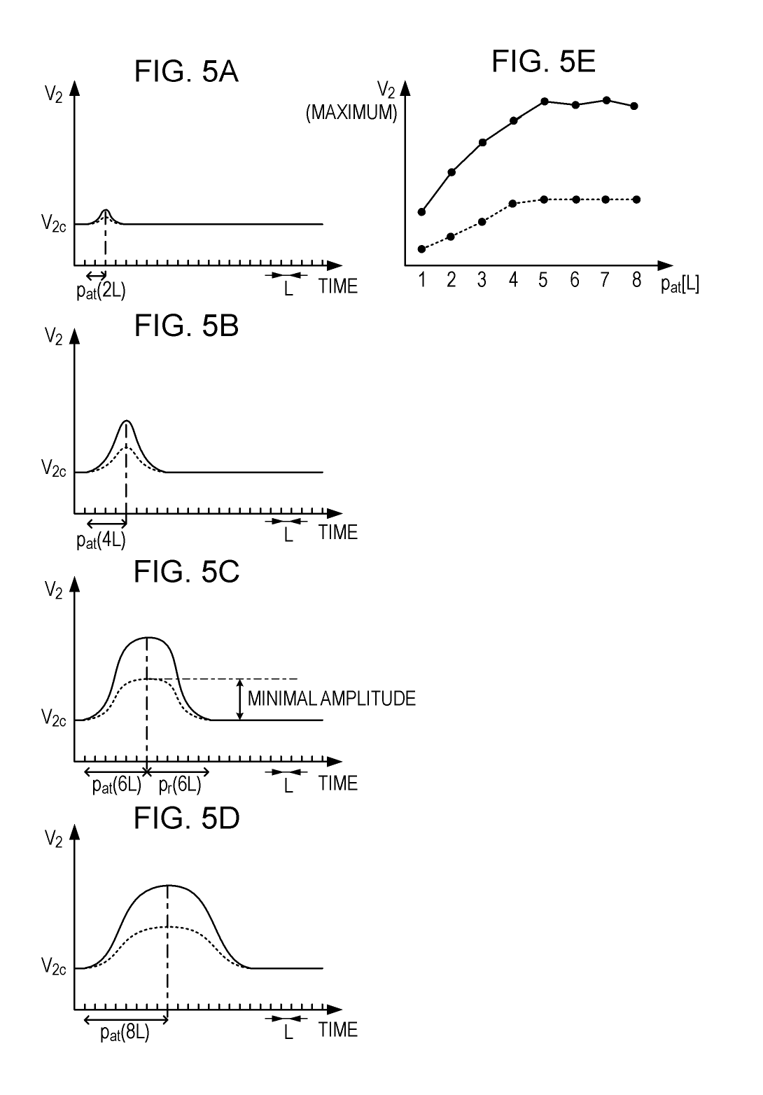

FIG. 5A to FIG. 5D are graphs illustrating a detection voltage V₂ output from the second amplification circuit 56 when a test discharge period pₐₜ discharging an ink droplet from a nozzle 23 for four times for 1 latch period (L) continues during 2 latch periods (2L), 4 latch periods (4L), 6 latch periods (6L), 8 latch periods (8L). Each vertical axis of FIGS. 5A to 5D indicates a detection voltage V2, and each horizontal axis thereof indicates time. Before start of the test discharge period pₐₜ, by conducting an analog switch Y of the clamp circuit 55, an input voltage (intermediate voltage V₁) of the second amplification circuit 56 is clamped to a predetermined electric potential V1c. In addition, there is no influence from various types of noises.

As illustrated in FIGS. 5A to 5D, when an ink droplet from a nozzle 23 is discharged during each discharge period pₐₜ, one convex response wave is expressed in a detection voltage V2 at an upper side. The response wave reflects a charge variation amount ΔQ corresponding to a sum of charges carried by each ink droplet landed on the detection electrode 31 during a test discharge period pₐₜ. The response wave is slowly increased from a detection voltage V₂ (predetermined electric potential V_{2c} by graph) in start of a test discharge period pₐₜ and becomes a maximum value, and again has a shape to be restricted to a predetermined electric potential V_{2c}. Here, because a landed location of an ink droplet in a nozzle plate 22 is changed according to nozzles 23, an ink amount of a discharged ink droplet is dispersed according to the nozzles 23, amplitude (difference between maximal detection voltage V₂ and predetermined electric potential V_{2c}) of a response wave of a detection electric potential V₂ is changed according to nozzles 23 even if the same test discharge period pₐₜ is used. In FIGS. 5A to 5D, a response wave with respect to a nozzle 23 having maximal amplitude is expressed with a solid line, and a response wave to a nozzle 23 having minimal amplitude is expressed with a broken line. Here, the longer a test discharge period pₐₜ is, the longer the period when an ink droplet is landed, and a response wave reflecting a charge variation amount ΔQ increases in the time axis direction. Here, a response wave of a detection voltage V2 corresponding to a charge variation amount ΔQ is not restricted to a predetermined electric potential V_{2c} at the same time in termination of the test discharge period pₐₜ, but is restricted to the predetermined electric potential V_{2c} dispersed after the termination of the test discharge period pₐₜ due to response characteristics of the foregoing signal generation circuits G1 and G2. A response wave becomes almost maximum value at a termination time of the test discharge period pₐₜ. That is why a charge is not carried by the ink droplet after the test discharge period pₐₜ, and a charge variation amount ΔQ is shifted to restriction. In addition, the longer the test discharge period pₐₜ is, the greater a sum of charges in which an ink droplet carries is. Accordingly, the amplitude of the response wave is increased. However, as the test discharge period pₐₜ as illustrated in FIGS. 5A to 5D increases, even though the test discharge period pₐₜ increases, amplitude of the response wave does not increase.

FIG. 5E is a graph illustrating relationship between the test discharge period pₐₜ and amplitude of a response wave (maximum value of detection voltage V₂). As illustrated in FIG. 5, in both of a response wave (solid line) with respect to a nozzle 23 having maximal amplitude and a response wave (broken line) with respect to a nozzle 23 having minimal amplitude, amplitude of a response wave is increased as a test discharge period Vₐₜ becomes during a test discharge period of 5 to 6 latch periods (5L to 6L) but an increase in amplitude of a response wave gets slow as the test discharge period pₐₜ becomes long when the test discharge period pₐₜ is equal to or greater than 5 to 6 latches (5L to 6L). Accordingly, by using a discharge period pₐ as 6 latch periods (6L), amplitude of the response wave is maximally secured, and the discharge period pₐ becomes long to prevent a period required for discharge testing from being long. Further, as illustrated in FIG. 5C, a response wave in timing after 6 latch periods 6L elapse after termination of a test discharge period pₐₜ of 6 latch period (6L) is restricted to a predetermined electric potential V_{2c}. In this embodiment, 6 latch periods (6L) after a discharge period pₐ is used as a non-discharge period pᵣ such that a response wave is not superimposed between different nozzles 23. So as to reduce a time period required for discharge testing, it is preferred that the non-discharge period pᵣ is set to be shorter as possible in a range which the response wave restricts. In this embodiment, a discharge testing period p around one nozzle by using the discharge period pₐ and the discharge period pₐ as 6 latch periods (6L) is used as 12 latch periods (12L 12×87 μs≅1 ms), and an actual testing period P1 is suppressed to about 2.88 seconds when 2880 nozzles 23 are sequentially tested. The description of FIG. 4 is returned to.

(d) of FIG. 4 illustrates a clamp signal S_{c} which the discharge testing controller 61 inputs to an analog switch Y of a clamp circuit 55. A period when the clamp signal S_{c} has 1 means a clamp period pc. In this embodiment, a final latch period of a non-discharge period pᵣ during a discharge testing period p becomes a clamp period pc. That is, a time period within 1 latch period (L) from timing making transition from a non-discharge period pᵣ pr to the discharge period pₐ becomes the clamp period p_{c}. Here, a start time of the clamp period p_{c} is identical with a discharge testing period p. A detection voltage V₂ during the clamp period p_{c} maintains a predetermined electric potential V_{2c}, and the detection voltage V₂ is changed corresponding to a charge variation amount ΔQ in a detection electrode 31 during time periods other than the clamp period p_{c}. Here, the clamp period pc may be also set to the foregoing prefix period p_{f}. In doing so, a detection voltage V₂ before the discharge testing may be restricted to a predetermined electric potential V_{2c}.

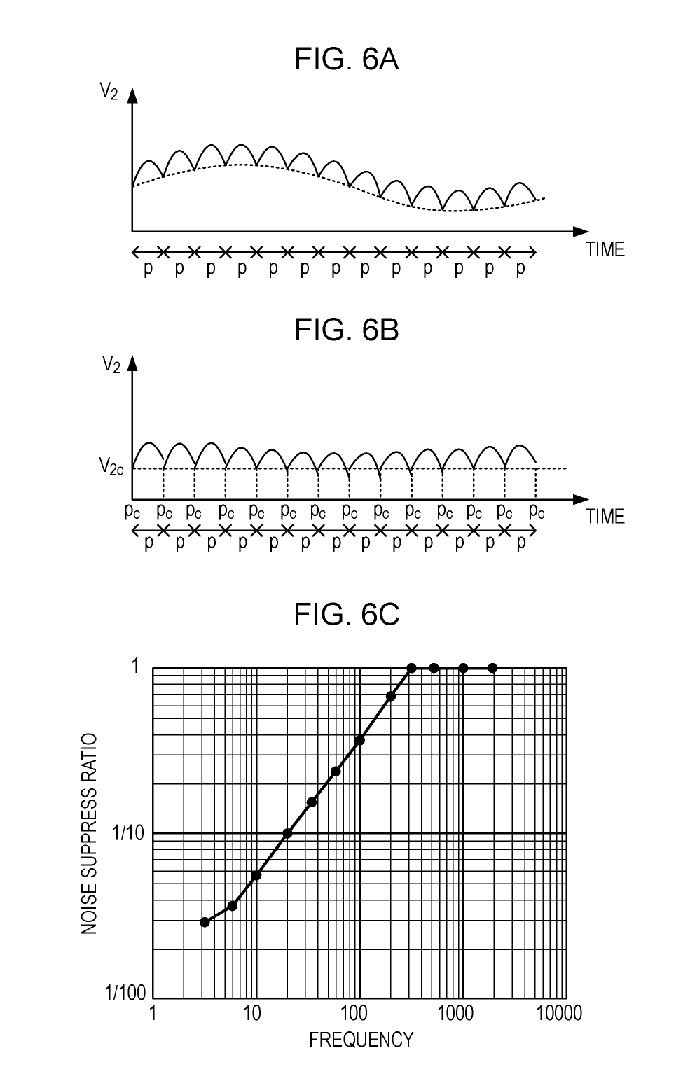

FIGS. 6A and 6B illustrate a detection voltage V₂ in a case where low frequency noise is included in comparison with the discharge testing period p, and in a case where an intermediate voltage V₁ is not clamped during the clamp period p_{c}, respectively. It is assumed that a voltage wave of low frequency noise is a sine wave. As illustrated in FIG. 6A, a response wave corresponding to a charge variation amount ΔQ in a detection electrode 31 in each of discharge testing periods p is expressed in the detection voltage V₂, but a noise (charge variation amount ΔQ occurring by vibration of detection electrode 31 or by another cause of magnetic disturbance) is superimposed. In response to this, an intermediate voltage V₁ in a clamp period p_{c} before each discharge testing period p (1 latch period L before termination) is clamped to a predetermined electric potential V_{1c} as illustrated in FIG. 6B, so that it may prevent low frequency noise from being accumulated between a plurality of discharge testing periods p. That is, the low frequency noise may be prevented from being accumulated through a plurality of discharge testing periods p, and a detection voltage V₂ restricting a ratio of low frequency noise strength to a signal strength of a response wave of a charge variation amount ΔQ may be obtained. In addition, because an intermediate voltage V₁ is restricted to about a predetermined electric potential V_{1c}, it may prevent the intermediate voltage V₁ from being beyond a voltage range which an operational amplifier A1 may output.

FIG. 6C is a graph illustrating noise suppression characteristic of a detection voltage V₂. The horizontal axis of FIG. 6 illustrates a noise frequency (log) and a vertical thereof illustrates a signal suppression ratio (input power/pass power) (log). Test noise of each frequency is intentionally injected in an input point of the first amplification circuit 54, and pass power of noise having a detection voltage V₂ is inspected. As illustrated in FIG. 6, it is understood that test noise of a frequency band (200 to 2000 Hz) corresponding to the same period as that of the discharge testing period p is passed to an output point of the second amplification circuit 56 almost without attenuation, and a response wave of a charge variation amount ΔQ is passed. This is why a time period of a clamp period p_{c} is identical with a discharge testing period p, and a wave of test noise of a high frequency band corresponding to a time period shorter than the discharge testing period p is not influenced by clamp. Here, a noise component of a frequency band higher than 2000 Hz may be suppressed by the low-pass filter circuit 53. On the other hand, in a low frequency band (to 200 Hz) corresponding to a period higher than the discharge testing period p, a frequency of test noise is reduced and suppressed. Concretely, pass power of test noise is attenuated by −20 dB for each 1 decade of a frequency (each time frequency increases 10 fold). Here, a gradient of a signal suppression ratio is alleviated in a low frequency band (to 5 Hz). However, in order to increase a noise suppression effect by clamping, regardless of reducing an amplification coefficient X₁ of the first amplification circuit 54, in a low frequency band (to 5 Hz), because a larger noise component may be suppressed, as an intermediate voltage V₁ in an output terminal (Vₒᵤₜ) of an operational amplifier (OP) A1 constructing a first amplification circuit 54 is clamped within an output allowable voltage range, a wave is distorted.

In this embodiment, an output possible voltage range of an operational amplifier A1 constituting the first amplification circuit 54 is about 3.3V, and an amplification coefficient X₁ of the first amplification circuit 54 is set such that amplitude of a response wave of an intermediate voltage V₁ in a clamp point CP becomes 1/100 to 1/10 (0.033 to 0.33V_{PP}) of an output possible voltage range. In doing so, although a voltage of noise in the clamp point CP varies by about −0.6 to 2.7 V, the intermediate voltage V₁ exceeds an output possible voltage range of the operational amplifier A1, and the corresponding intermediate voltage V₁ may be prevented from being clamped. That is, a response wave of a charge variation amount ΔQ in a detection electrode 31 may be prevented from being distorted by clamp of the intermediate voltage V₁, and it may be determined with precision whether an ink droplet is discharged. Here, although an amplification coefficient X₁ of the first amplification circuit 54 is small, because a second amplification circuit 56 further amplifying a clamped intermediate voltage V₁ is provided, a suitable detection voltage V₂ for determining whether an ink droplet is discharged may be obtained. Here, when a voltage of a noise component in the clamp point CP varies by about 0 to 0.3 V, clamp of the response wave may be prevented by switching a predetermined electric potential V_{1c} conducting and clamping the switch W from 0.6 to 0V. The description of FIG. 4 is returned to.

(e) of FIG. 4 illustrates a sampling period ps such that a discharge testing controller 61 acquires a voltage value of a detection voltage V₂ by an A/D converter 61a, and a solid line of (f) of FIG. 4 illustrates a response wave (noise component is disregarded) of a detection voltage V₂ corresponding to a charge variation amount ΔQ. Further, a dashed line of (f) of FIG. 4 illustrates a detection voltage V₂ in a case where an ink droplet is not discharged (charge variation amount ΔQ becomes 0) during the discharge period V₂. In this embodiment, a sampling period ps starts from timing transiting from the discharge period pₐ to a non-discharge period pᵣ, and a sampling period ps is terminated before 1 latch period (L) elapses from a corresponding start time. In doing so, a voltage value of a detection voltage V₂ may be obtained in timing when a response wave of a charge variation amount in a detection electrode 31 becomes a maximum value. Here, an interval from end of the clamp period to start of a sampling period pₛ corresponds to a restoration period until a detection voltage V₂ starts increase and becomes a maximum value. Further, a variation amount of a detection voltage V₂ from a clamp period p_{c} to a sampling period pₛ corresponds to the amplitude of a response wave of a charge variation amount ΔQ in the detection electrode 31. In doing so, by using an interval from a clamp period p_{c} to a sampling period pₛ as an interval when a variation amount of a detection voltage V₂ is increased at a maximum, the contribution degree of a noise component of a detection voltage V₂ in a sampling period pₛ may be relatively reduced.

Further, because a voltage value of a predetermined electric potential V_{2c} in a clamp period p_{c} is constant, a voltage value of a detection voltage V₂ in a sampling period ps uniquely corresponds to amplitude of a response wave of a charge variation amount ΔQ in a detection electrode 31. That is, it may be determined that the amplitude of a response wave of a charge variation amount ΔQ in a detection electrode 31 is great insomuch that a voltage value of a detection voltage V₂ in the sampling period is great. Moreover, if the amplitude of a response wave of a charge variation amount ΔQ is great, it may be determined that an ink droplet is normally discharged. Here, in this embodiment, in a case where a voltage value of a detection voltage V₂ in a sampling period pₛ is equal to or greater than corresponding threshold by using a voltage value (Vₐₜₕ+V_{2c}) obtained by adding a predetermined electric potential V2c to an amplitude threshold Vₐₜₕ corresponding to minimal amplitude of a response wave shown with a broken line in FIG. 5 as threshold, the discharge testing controller 61 determines that an ink droplet is normally discharged. In other words, in case where a variation amount of a detection voltage V₂ from a clamp period p_{c} to a sampling period ps is equal to or greater than the amplitude threshold Vₐₜₕ, the discharge testing controller 61 determines that the ink droplet is normally discharged. Here, the amplitude threshold Vₐₜₕ may be an average amplitude of a response wave shown in FIG. 5, or a value obtained by adding a margin corresponding to a noise component to minimal amplitude or average amplitude may be used as amplitude threshold Vₐₜₕ. Here, data indicating a threshold are recorded on a recording medium (ROM, register or the like) readable by the discharge testing controller 61.

The discharge testing controller 61 outputs data indicating the nozzle number of a nozzle 23 from which an ink droplet is normally discharged to a main controller 11 of a main substrate 10 when it is determined that an ink droplet is normally discharged. Then, a main controller 11 of the main substrate 10 performs a notice indicating meaning that an ink droplet is normally discharged together with a nozzle number of the nozzle 23 to which the ink droplet is normally discharged. Here, the discharge testing controller 61 or the main controller 11 may accumulate data indicating the nozzle number of a nozzle 23 to which the ink droplet is normally discharged, and collectively notice a nozzle number of a nozzle 23 to which the ink droplet is not discharged as a state terminating discharge testing for all nozzles 23. In addition, the main controller 11 may perform an abnormal restoration operation (flushing, suction, etc.) or repeated discharge testing according to presence or the number of the nozzle 23 to which an ink droplet is not normally discharged.

Here, in this embodiment, because there are two signal generation circuits G1 and G2 including a high voltage cut-off capacitor 52, a low-pass filter circuit 53, a first amplification circuit 54, a clamp circuit 55, a second amplification circuit 56, discharge testing for different nozzles 23 is performed in a parallel way in the signal generation circuits G1 and G2. In doing so, a time interval required for discharge testing for all nozzles 23 may be reduced. Obviously, discharge testing of a nozzle 23 may be performed in different times in the signal generation circuits G1 and G2. A discharge testing period p in the signal generation circuits G1 and G2 may also be synchronized.

As illustrated previously, in this embodiment, a clamp circuit 55 synchronizes with the discharge testing period p to clamp an intermediate voltage V₁ to a predetermined electric potential V1c, so that a low frequency noise component may be eliminated from the detection voltage V₂, and discharge abnormality determination having high resistance to noise may be implemented. Further, because a low frequency noise component is eliminated from clamp, in comparison with a case where a low frequency noise component is eliminated using a band-pass (high pass) filter, distortion or delay of a response wave of a charge variation amount ΔQ in the detection electrode 31 may be suppressed. Accordingly, a period required for discharge testing of each nozzle 23 may be reduced, and discharge testing of a plurality of nozzles 23 may be terminated within a short time.

### 3. SECOND EMBODIMENT

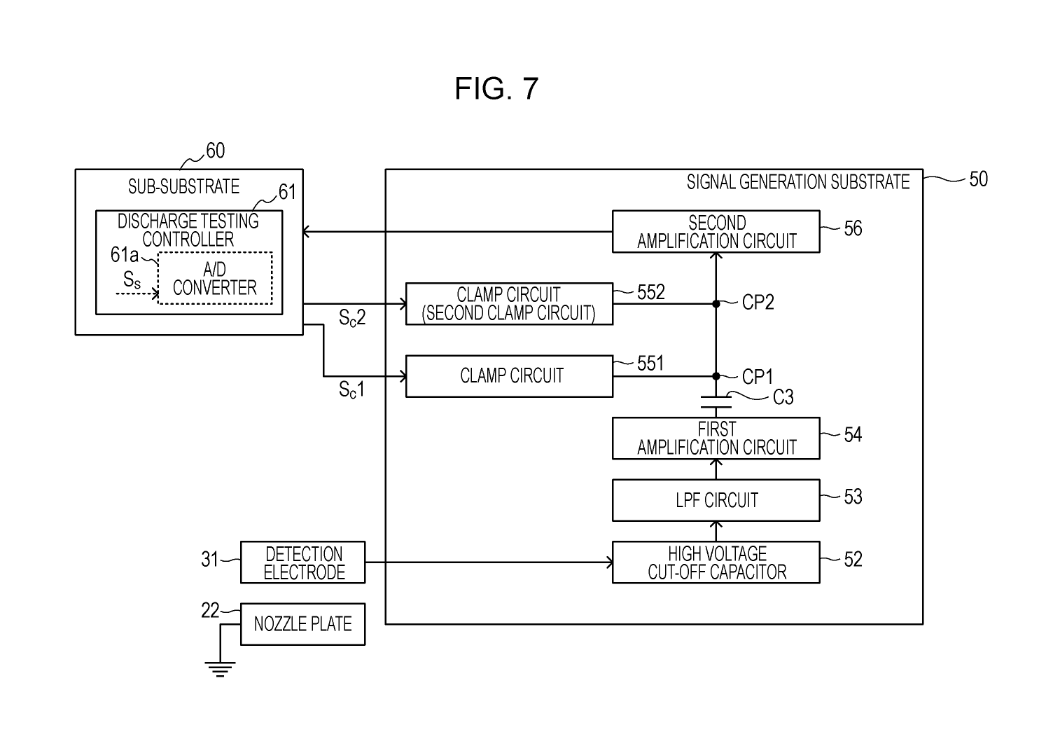

FIG. 7 is a block diagram illustrating main parts of a discharge testing device according to a second embodiment. Here, only matters differing from those of the first embodiment will be described in the second embodiment. In the second embodiment, two clamp circuits 551 and 552 are provided. The clamp circuit 552 corresponds to a second clamp circuit. The clamp circuit 551 inputs a predetermined electric potential V_{1c1} (=0V) to a clamp point CP1 of a coupling capacitor C3 side, and the clamp circuit 552 inputs a predetermined electric potential V_{1c1} (=0.6V) to a clamp point CP2 of a second amplification circuit 56 side. Clamp signals S_{c1}, and S_{c2} are input to the clamp circuits 551 and 552 through separate wires from a discharge controller 61 of a sub-substrate 60, respectively.

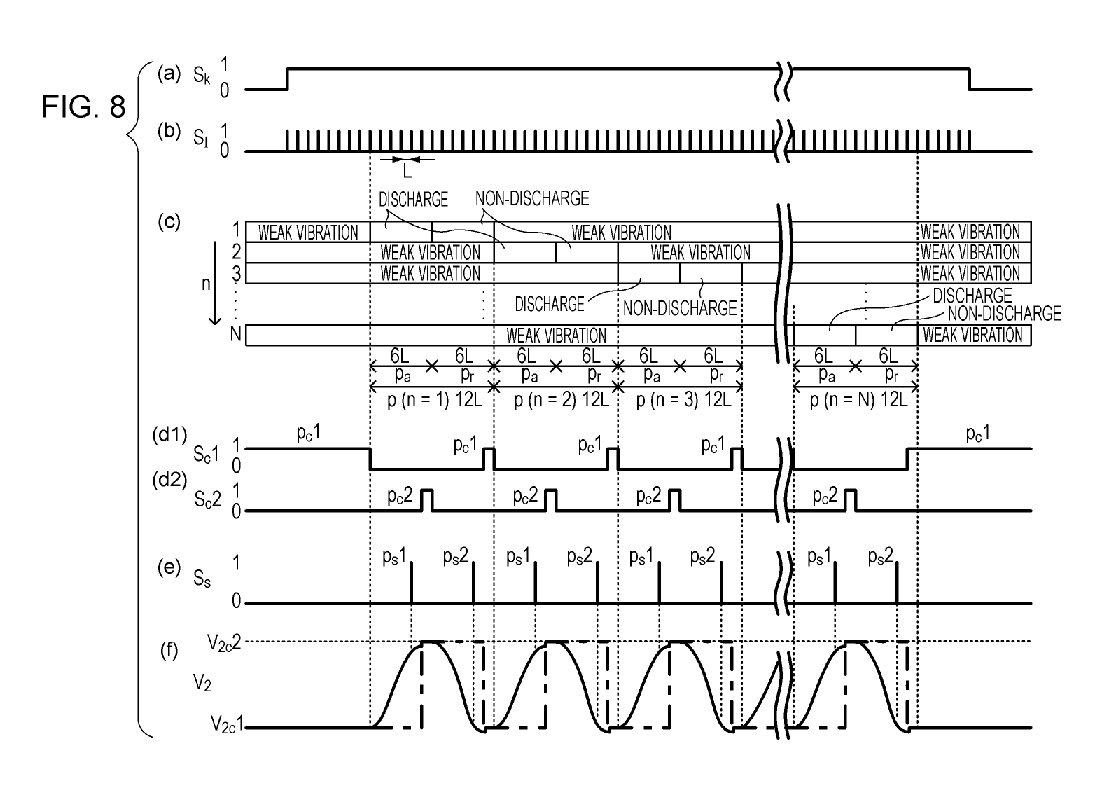

FIG. 8 is a timing chart of a discharge testing according to a second embodiment. (d1) and (d2) of FIG. 8 illustrate clamp signals S_{c1} and S_{c2} input to the clamp circuits 551 and 552, respectively. A 1 latch period (L) before the end of a non-discharge period pᵣ with respect to the clamp circuit 551 becomes a clamp period p_{c1} in the same manner as in the first embodiment. Meanwhile, one latch period (L) before an end of a discharge period pₐ with respect to the clamp circuit 552 becomes a clamp period (second clamp period p_{c2}). In addition, as illustrated in (e) of FIG. 8, a time period before a predetermined time interval from transiting timing from a discharge period pₐ to a non-discharge period pᵣ, and a time period before the clamp period p_{c2} becomes a sampling period pₛ₁. In addition, as illustrated in (e) of FIG. 8, a period before a predetermined period from timing transiting from a non-discharge period pᵣ to a discharge period pₐ, and before the clamp period p_{c1}, becomes a sampling period (second sampling period pₛ₂).

A solid line of (f) FIG. 8 illustrates a response wave (noise component is disregarded) of a detection voltage V₂ according to a charge variation amount ΔQ. Further, a dashed line of (f) of FIG. 8 illustrates a detection voltage V₂ in a case where an ink droplet is not discharged in a discharge period pₐ (case where charge variation amount is not zero). As illustrated in (f) of FIG. 8, the clamp circuit 551 clamps an intermediate voltage V₁ in a predetermined electric potential V_{1c1} before start of a discharge period pₐ, and a discharge testing controller 61 immediately before termination of the discharge period pₐ acquires a voltage value of a detection voltage V₂, so that a detection voltage v₂ from a predetermined electric potential V_{2c1} corresponding to a predetermined electric potential V_{1c1} may specify amplitude of a response wave to become a maximum value. In the same manner as in the first embodiment, a discharge controller 61 determines that an ink droplet is normally discharged when a voltage value of a detection voltage V₂ in a sampling period pₛ₁ is equal to or greater than a threshold (first threshold). A first threshold is identical with that of the first embodiment. In addition, a clamp circuit 552 clamps an intermediate voltage V₁ in a predetermined electric potential V_{1c2} immediately before start of a non-discharge period pᵣ, and a discharge testing controller 61 acquires a voltage value of the detection voltage V₂ immediately before the non-discharge period pᵣ, to specify amplitude of a response wave until a detection voltage V₂ from a predetermined electric potential V_{2c2} corresponding to a predetermined electric potential V_{1c2} decreased and restricted. The discharge testing controller 61 may determine that an ink droplet is normally discharged when a voltage value of a detection voltage V₂ obtained in the sampling period pₛ₂ is less than or equal to a threshold (second threshold). For example, the second threshold becomes a value obtained by subtracting an amplitude threshold Vₐₜₕ from a predetermined electric potential V_{2c2}.

The discharge testing controller 61 notifies a corresponding determination result as final and conclusive when a determination result based on a voltage value of a detection voltage V₂ in a sampling period pₛ₁ accords with a determination result based on a voltage value of a detection voltage V₂ in the sampling period pₛ₂. In the meantime, when a determination result based on a voltage value of a detection voltage V₂ in a sampling period pₛ₁ disaccords with a determination result based on a voltage value of a detection voltage V₂ in a sampling period pₛ₂, reliability of a corresponding determination result is low, so that discharge testing with respect to the same nozzle 23 is performed again. In this case, it is assumed to be influenced by a low frequency noise component. That is, the low frequency noise component tends to be increased monotonically, a determination result readily becomes normal based on a voltage value of a detection voltage V₂ during the sampling period pₛ₁, and a determination result readily becomes abnormal based on a voltage value of a detection voltage V₂ during the sampling period pₛ₂. Conversely, the low frequency noise component tends to be reduced monotonically, a determination result readily becomes abnormal based on a voltage value of a detection voltage V₂ during the sampling period pₛ₁, and a determination result readily becomes normal based on a voltage value of a detection voltage V₂ during the sampling period pₛ₂. Here, the lower the frequency of the noise component, the higher the probability of a noise component during a single discharge testing period p having a monitonical reduction trend or monotonical increase trend.

As illustrated above, two pairs of clamp periods p_{c} and sampling periods pₛ are provided, and it may be determined twice whether an ink droplet is normally discharged between a single discharge testing period with respect to a single nozzle 23. A low frequency noise component is eliminated by the clamp circuits 551 and 552, so that delay in a response wave of a charge variation ΔQ in a detection electrode 31. Accordingly, although clamp with the clamp circuits 551 and 552 is performed twice, the discharge testing period is set within a short time interval. Further, a corresponding determination result is finally concluded in a case where a determination result based on a voltage value of a detection voltage V₂ in a sampling period Psi accords with a determination result based on a voltage value of a detection voltage V₂ in a sampling period pₛ₂, such that abnormal discharge of high reliability may be implemented. In particular, in a case where a low frequency noise component is superimposed on a detection voltage V₂, because the determination result based on a voltage value of a detection voltage V₂ in a sampling period pₛ₁ disaccords with the determination result based on a voltage value of a detection voltage V₂ in a sampling period Pₛ₂, abnormal discharge with high reliability may be implemented. Because clamp for a single discharge period is performed twice, a suppression effect of a low frequency noise component by clamp may be improved.

### 4. ANOTHER Embodiment

In the foregoing embodiment, noise components of a high frequency and a low frequency are eliminated and suppressed by a low-pass filter circuit 53 and a clamp circuit 55, but a noise component of a time period around a time period where a charge variation amount ΔQ in a detection electrode 31 is generated influences on the detection voltage V₂. Among the foregoing noise components, appearance timing expressed in the detection voltage V₂ may reduce influence in comparison with delaying the sampling period pₛ from appearance timing with respect to a known noise component. Here, a noise component where appearance timing is known is a noise component induced in an operation performed actively by the printer 1, in particular, a noise component occurring in an operation of a print head 20 easily has an effect on the detection voltage V₂. In this embodiment, a nozzle value 22 is formed by a silicon crystal other than metal. A nozzle plate 22 is formed by a silicon crystal, so that it has a merit that a minute structure such as a nozzle 23 may be formed using a silicon process used in semiconductor processing. However, because the nozzle plate 22 formed by a silicon crystal has a conductivity lower than that of a nozzle plate 22 formed by metal, shield effect by the nozzle plate 22 is lower than that of the first embodiment. Accordingly, a noise component occurring in various types of electric signals in the print head 20 is more easily superimposed on a detection voltage V₂ in comparison with the first embodiment.

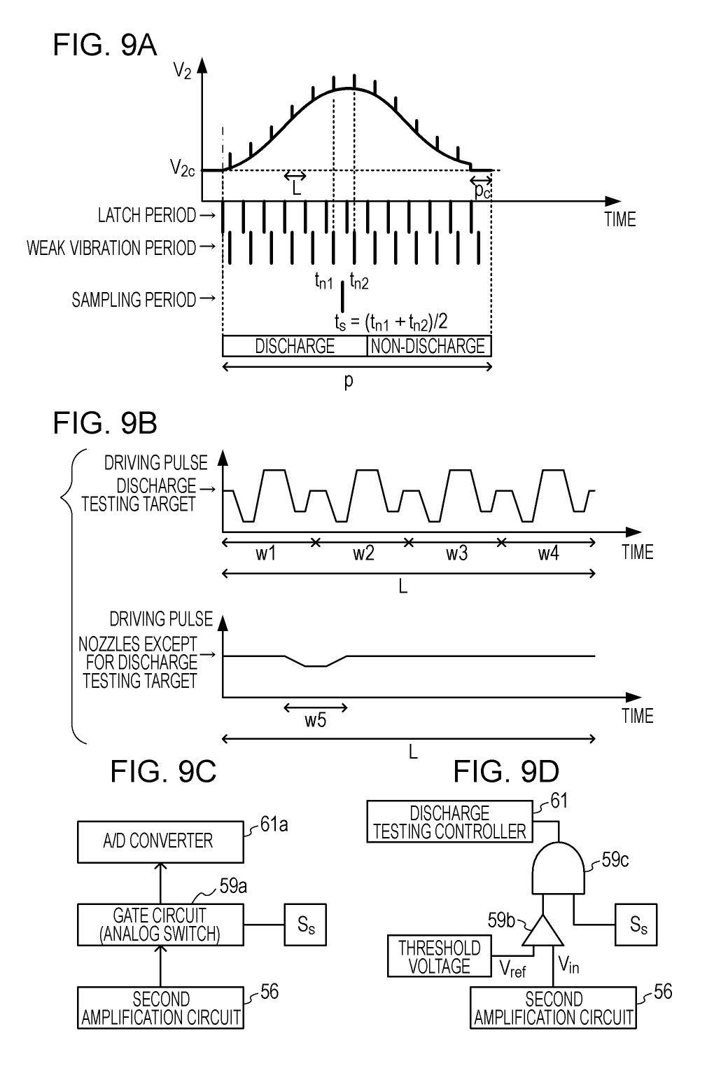

FIG. 9A is a graph illustrating a detection voltage V2 according to this embodiment. As illustrated in FIG. 9A, a period noise component having the same period as the latch period and having a predetermined phase difference from a latch period is superimposed on the detection voltage V₂. A noise component of this period occurs due to a driving pulse the main substrate 10 outputs to the print head 20 to minutely vibrate a piezoelectric element 21. The small vibration driving indicates driving for minute vibration an ink droplet surface in a nozzle 23 such that the ink droplet is not discharged by driving a piezoelectric element 21 corresponding to a nozzle 23 other than nozzle 23 of the discharge testing target.

FIG. 9B illustrates a driving pulse output to the print head 20. The horizontal axis of FIG. 9B illustrates the time from start of a latch period to termination thereof, and the vertical axis thereof illustrates a voltage of a driving pulse. An upper item of FIG. 9B illustrates a driving pulse output to 1 latch period (L) belonging to a discharge period pₐ with respect to a piezoelectric element corresponding to a nozzle 23 of a discharge testing target, and a lower item of FIG. 9B illustrates a driving pulse output to 1 latch period (L) with respect to a piezoelectric element 21 corresponding to a nozzle 23 which is not a discharge testing target. As illustrated above in an upper item of FIG. 9B, a driving pulse including four discharge waves w1 to w4 for discharging an ink droplet with respect to a piezoelectric element 21 corresponding to a nozzle 23 of a discharge testing target is output during a discharge period pₐ. On the other hand, as illustrated in a lower end of FIG. 9B, a driving pulse including one minute vibration wave w5 for slightly vibrating an ink droplet surface with respect to a piezoelectric element 21 corresponding to a nozzle 23 which is not a discharge testing target is output. Here, a time (phase) when respective waves w1 to w5 are output is constant during a latch period, and particularly, a minute vibration wave w5 may be output with an output period (small vibration period) having the same length as that of a latch period.

When the small vibration wave w5 is uniformly output with respect to a plurality of piezoelectric elements corresponding to a nozzle 23 which is not a discharge testing target, an ink component is superimposed on a detection voltage V₂ corresponding to an output period of a minute vibration wave w5. A noise magnetic wave originating from an inside of a print head 20 to a minute vibration wave w5 is generated, and transmits a nozzle plate 22 and is radiated to a signal generation substrate 50. In a detection voltage V₂ illustrated in FIG. 9A, a weak vibration noise component corresponding to a weak vibration wave form w5 having the same length as that of the latch period is superimposed, and amplitude thereof becomes amplitude similar to amplitude of a response wave of a charge variation amount ΔQ. Here, because a weak vibration noise component has a frequency (1/12) similar to a frequency of a response wave of a charge variation amount ΔQ, if a low-pass filter circuit 53 is constructed such that the weak vibration noise component is eliminated, a response wave of a charge variation amount ΔQ is suppressed. In addition, due to clamp by the clamp circuit 55, a weak vibration noise component having a frequency higher than that of a response wave of a charge variation amount ΔQ may not be eliminated. Here, in this embodiment, during an appearance time of a weak vibration noise component generated during a weak vibration period, a response wave of a charge variation amount ΔQ has a period centered around an average time is of two times tₙ₁ and tₙ₂. Concretely, a sampling period becomes a period within a predetermined period (shorter than a half of latch period) before and after an average time tₛ. It is determined whether an ink droplet based on a voltage value of a detection electrode V₂ in the foregoing sampling period ps is normally discharged, so that influence from a weak vibration noise component is suppressed, and discharge abnormality determination having high reliability may be implemented.

FIG. 9C is a block diagram illustrating a circuit acquiring a voltage value of only a detection voltage V₂ during a sampling period pₛ. When the detection voltage V₂ is output to an A/D converter 61a of a discharge testing controller 61, a sampling signal Sₛ becoming 1 during the sampling period pₛ may be output to a gate circuit 59a. Moreover, a binary signal binarized according to whether a detection voltage V₂ is greater than a threshold may be output to a discharge testing controller 61. In doing so, a discharge testing controller 61 may determine whether an ink droplet is normally discharged based on a signal obtained by binarizing the detection voltage V₂.

FIG. 9D is a block diagram illustrating a circuit outputting a binarized signal to the discharge testing controller 61 during only a sampling period pₛ. A detection voltage V₂ from the second amplification circuit 56 is compared with a threshold voltage by a comparator 59. When the detection voltage V₂ is greater than a threshold voltage, a signal level in an output terminal of the comparator 59b becomes 1. When an output terminal of the comparator 59b is connected to an AND gate 59c, and the sampling signal has 1, an output signal of the comparator 59b is input to a discharge testing controller 61. Here, the threshold voltage is a voltage corresponding to a threshold of the first embodiment.

Here, in the foregoing embodiment, a detection electrode 31 is provided at a nozzle cap 30, but the detection electrode 31 may be separately provided. Further, capacitance between the detection electrode 31 and the nozzle plate 22 may be parasitized, the detection electrode 31 may be grounded, and a high voltage may be output to a nozzle plate 22 side. In addition, the detection electrode 31 may not be configured such that an ink droplet is landed, for example, an ink droplet may be discharged parallel with the detection electrode 31 and a facing electrode facing each other in parallel between the detection electrode 31 and a facing electrode. Further, the detection electrode 31 may not configure a capacitor, and may be configured such that an induced current flows by approach of a charged ink. In addition, the detection electrode 31 may be configured such that a response wave of physical amount variation caused by an ink droplet. For example, received strength of a magnetic wave, such as visible light, interfered due to a discharged ink droplet may be detected as a detection signal. When the detection signal is detected by some of the approaches, because a low frequency noise component is obtained to be superimposed on a detection signal, it is preferred that a response speed in the clamp circuit 55 is not reduced, and a low frequency noise component is eliminated. The nozzle 23 may be configured to discharge an ink droplet, and the ink droplet may be discharged by a thermal ink-jet method. The ink droplet is not limited to an ink droplet using appearance of a color a main purpose. That is, a liquid droplet whose physical amount varies by a discharged object is applicable to the discharge testing method of the invention.

Further, there is not a need that two signal generation circuits G1 and G2 are provided on a signal generation substrate 50 as illustrated in the foregoing embodiment, but one or three signal generation circuit may be provided. Moreover, signal generation circuits G1 and G2 of the foregoing embodiment generates a signal such that a detection voltage V₂ is convex at an upper side but the detection voltage V₂ may be convex at a lower side. In this case, when the detection voltage V₂ is less than or equal to a predetermined threshold, namely, it may be determined that a detection voltage V₂ decreases by greater than a predetermined value between a clamp period p_{c} and a sampling period ps, and an ink droplet is normally discharged. Here, as in the second embodiment, when a second clamp period p_{c}2 and a second sampling period Pₛ₂ are set, it may be determined that a detection voltage V₂ between the second clamp period p_{c}2 and the second sampling period Pₛ₂ is increased by greater than a predetermined value, and the ink droplet is normally discharged. In addition, a discharge testing controller 61 may be not provided at a sub-substrate 60, for example, be provided at a main substrate 10, and be built-in the main controller 11.

What is claimed is:

1. A discharge testing device comprising:
a discharge controller discharging a liquid droplet from a nozzle such that a discharge testing period including a discharge period where the liquid droplet from the nozzle is discharged and a non-discharge period where the liquid droplet from the nozzle is not discharged are repeated;
a detection signal acquiring unit acquiring a detection signal whose signal strength varies according to a liquid droplet discharged from the nozzle during the discharge period;
a low-pass filter eliminating a high frequency component from the detection signal;
a first amplifier amplifying the detection signal to generate a first amplification signal;
a restricting unit restricting signal strength of the first amplification signal during a restriction period included in the discharge testing period to predetermined strength;
a second amplifier amplifying the first amplification signal to generate a second amplification signal; and
a determinator determining whether a liquid droplet is normally discharged based on signal strength based on signal strength of a second amplification signal during a sampling period after a predetermined time elapses from the restriction period.

2. The discharge testing device according to claim 1, wherein the first amplifier generates the first amplification signal indicating a voltage varying according to a liquid droplet discharged from a nozzle during the discharge period in the first amplification circuit,
the second amplifier amplifies a first amplification signal in a second amplification circuit, and
the restricting unit includes
a coupling capacitor provided between an output terminal of the first amplification circuit and an input terminal of the second amplification circuit,
a restricting point provided between the coupling capacitor and the input terminal of the second amplification circuit,
a power circuit generating power of a predetermined electric potential as the predetermined strength, and
a switch inputting the power to the restricting point during the restriction period.

3. The discharge testing device according to claim 1, further comprising a secondary restricting unit restricting signal strength of the first amplification signal during a secondary restriction period after the sampling period during the discharge testing period,
wherein the determinator determines whether an ink droplet is normally discharged from the nozzle based on a combination of signal strength of the second amplification signal during a secondary sampling period after a predetermined time elapses from the secondary restriction period and signal strength of the second amplification signal during the sampling period.

4. The discharge testing device according to claim 1, further comprising a switch switching the predetermined strength to any one of a plurality of strengths.

5. The discharge testing device according to claim 1, further comprising a plurality of signal generators that include the detection signal acquiring unit, the low-pass filter, the first amplifier, the restricting unit, and the second amplifier,
wherein the detection signal acquiring units included in each of the plurality of signal generator acquires a detection signal whose signal strength varies in response to a liquid droplet discharged from the different nozzles.
